(19) United States
(12) Patent Application Publication
(10) Pub. No.: US 2025/0244464 A1
(43) Pub. Date: Jul. 31, 2025

(54) RADAR SYSTEM AND VELOCITY CORRECTION METHOD THEREOF

(71) Applicant: Wistron NeWeb Corporation, Hsinchu (TW)

(72) Inventors: Chi-Yung LIAO, Hsinchu (TW); Modick Bahadur BASNET, Hsinchu (TW); Chi-Cheng KUO, Hsinchu (TW); Shu-Hao LIU, Hsinchu (TW)

(21) Appl. No.: 18/426,560

(22) Filed: Jan. 30, 2024

(51) Int. Cl. G01S 13/58; G01S 13/42; G01S 13/931

(52) U.S. Cl. CPC G01S 13/584; G01S 13/42; G01S 13/931

(57) ABSTRACT

A radar system includes multiple radio frequency (RF) circuits and a processing circuit. The RF circuits obtain multiple RF signals with respect to an object. The processing circuit is configured to measure a range and an angle of the object related to the radar system according to the RF signals, and calculates coordinates according to the range and the angle in each of multiple cycles. The processing circuit also obtains multiple combinations among the cycles, in which each combination corresponds to two cycles. For each combination, the processing circuit calculates velocities according to the corresponding coordinates and a cycle difference. The processing circuit also calculates at least one statistic value of the velocities of the combinations, and calculates a corrected velocity according to the statistic value.

### BACKGROUND

### Field of Invention

This disclosure relates to a velocity correction method for a radar system, where accurate velocities can be calculated through statistical values of multiple combinations.

### Description of Related Art

Radar is a system that uses radio waves to detect a range, a velocity, and an angle of an object. When measuring the range, the radar system emits a beam of radio waves from its antenna. When these radio waves encounter a target object, a portion of the waves is reflected back to the radar system. The radar system calculates the range based on the time required for the radio waves to be emitted and return. The velocity calculation relies on the Doppler Effect. The radar system calculates the frequency difference between the emitted and received radio waves, and using this frequency difference and the frequency of the emitted wave, the velocity of the object can be calculated. The radar system can also be configured with a directional antenna; the direction of the returning waves can be used to calculate the angle of the target object relative to the radar. However, when the angle between the target object and the radar system falls within a specific range, it can lead to inaccurate velocity measurements. How to resolve this issue is a matter of concern for technical experts in this field.

### SUMMARY

Embodiments of the present disclosure provide a radar system including multiple radio frequency (RF) circuits and a processing circuit. The RF circuits are configured to obtain multiple RF signals with respect to an object. The processing circuit is electrically connected to the RF circuits, and configured to measure a range and an angle of the object related to the radar system according to the RF signals, and calculate at least one coordinate according to the range and the angle in each of multiple cycles. The processing circuit is configured to obtain multiple combinations among the cycles, in which each of the combinations corresponds to two of the cycles. For each of the combinations, the processing circuit is configured to calculate at least one velocity according to the corresponding coordinates and a cycle difference. The processing circuit is configured to calculate at least one statistic value of the velocities of the combinations, and calculate a corrected velocity according to the at least one statistic value.

In some embodiments, the at least one coordinate includes a first coordinate and a second coordinate. The processing circuit is configured to calculate the first coordinate and the second coordinate based on following equations.

xᵢ=Rᵢ·cos(θᵢ)

yᵢ=Rᵢ· sin(θᵢ)

Where Rᵢ is the range measured in a i-th cycle of the cycles, θᵢ is the angle measured in the i-th cycle, xᵢ is the first coordinate calculated in the i-th cycle, yᵢ is the second coordinate calculated in the i-th cycle, and i is a positive integer.

In some embodiments, the at least one velocity includes a first velocity and a second velocity. A k-th combination of the combinations corresponds to the i-th cycle and a j-th cycle, and the processing circuit is configured to calculate the first velocity and the second velocity based on following equations.

$$\begin{matrix}{v}_{x , k} = \frac{( {x}_{i} - {x}_{j} )}{Δ T \cdot ( i - j )} \\ {v}_{y , k} = \frac{( {y}_{i} - {y}_{j} )}{Δ T \cdot ( i - j )}\end{matrix}$$

Where v_{x,k} is the first velocity of the k-th combination, v_{y,k} is the second velocity of the k-th combination, ΔT is cycle time, and k is a positive integer.

In some embodiments, the processing circuit is configured to determine if a number of the cycles is greater than a cycle count, and if not, process a next cycle, and if yes, stop processing the next cycle.

In some embodiments, the processing circuit is configured to determine, in one of the cycles, if the corresponding range is greater than a range threshold, and if yes, set the cycle count to be a first value, and if not, set the cycle count to be a second value, in which the first value is greater than the second value.

In some embodiments, the processing circuit is configured to determine if a difference among the first velocities of n continuous cycles is less than a velocity threshold and a difference among the second velocities of the n continuous cycles is less than the velocity threshold, and if yes, stop processing the next cycle, and if not, process the next cycle, in which n is a positive integer greater than 1.

In some embodiments, the at least one statistic value includes a mean and a standard deviation of the velocities of the combinations. The processing circuit is configured to set a grouping range according to the mean and the standard deviation, separate the velocities within the grouping range into multiple bins, and determine the corrected velocity according to a most repeating bin of the bins.

In some embodiments, the processing circuit is configured to set the grouping range to be from the mean minus the standard deviation to the mean plus the standard deviation.

In some embodiments, the processing circuit is configured to set a center of the most repeating bin to be the corrected velocity.

In some embodiments, the processing circuit is configured to perform a clustering algorithm, an association algorithm, or a tracking algorithm according to the corrected velocity.

From another aspect, embodiments of the present disclosure provide a velocity correction method for a radar system and performed by a processing circuit. The velocity correction method includes: obtaining, by multiple radio frequency (RF) circuits, multiple RF signals with respect to an object; measuring a range and an angle of the object related to the radar system according to the RF signals, and calculating at least one coordinate according to the range and the angle in each of multiple cycles; obtaining multiple combinations among the cycles, in which each of the combinations corresponds to two of the cycles; for each of the combinations, calculating at least one velocity according to the corresponding coordinates and a cycle difference; and calculating at least one statistic value of the velocities of the combinations, and calculating a corrected velocity according to the at least one statistic value.

### BRIEF DESCRIPTION OF THE DRAWINGS

FIG. 1 is a schematic diagram illustrating a radar system according to one embodiment.

FIG. 2 is a flowchart illustrating a velocity correction method according to one embodiment.

FIG. 3 is a diagram illustrating a coordinate system of the radar system according to one embodiment.

FIGS. 4 to 6 illustrate data diagrams for calculating the corrected velocity according to an embodiment.

FIG. 7A to FIG. 7F illustrate diagrams of experimental results according to embodiments.

FIGS. 8A and 8B illustrate flowcharts of a velocity correction method according to another embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence.

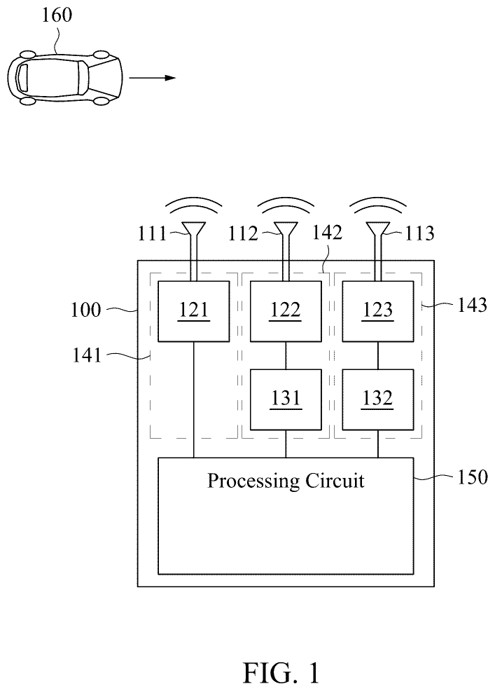

FIG. 1 is a schematic diagram illustrating a radar system according to one embodiment. Referring to FIG. 1, a radar system 100 includes antennas 111-113, radio frequency (RF) circuits 141-143, and a processing circuit 150. The RF circuits 141-143 are electrically connected to antennas 111-113 respectively, and the processing circuit 150 is electrically connected to the RF circuits 141-143. The radar system 100 can be installed in a vehicle or in any device for measuring the velocity of an object 160.

The antennas 111-113 are used to transmit and receive radio waves. The RF circuit 141 includes an RF front-end 121, the RF circuit 142 includes an RF front-end 122 and an analog-to-digital converter 131, and the RF circuit 143 includes an RF front-end 123 and an analog-to-digital converter 132. In this embodiment, the RF front-end 121 is electrically connected to the processing circuit 150; the analog-to-digital converter 131 is electrically connected between the RF front-end 122 and the processing circuit 150; the analog-to-digital converter 132 is electrically connected between the RF front-end 123 and the processing circuit 150. The RF front ends 121-123 are electrically connected to the antennas 111-113 respectively, serving to amplify, frequency-convert, demodulate, and/or filter signals received by the antennas. In addition to the analog-to-digital converters 131-132, the RF circuits 141-143 can also include power amplifiers, mixers, filters, etc. Through the operation of these components, RF signals can be generated by the RF circuits 141-143, and these RF signals contain information such as a range (also referred to as a distance) and an angle of the object 160. The processing circuit 150 would execute a velocity correction method, which will be detailed below.

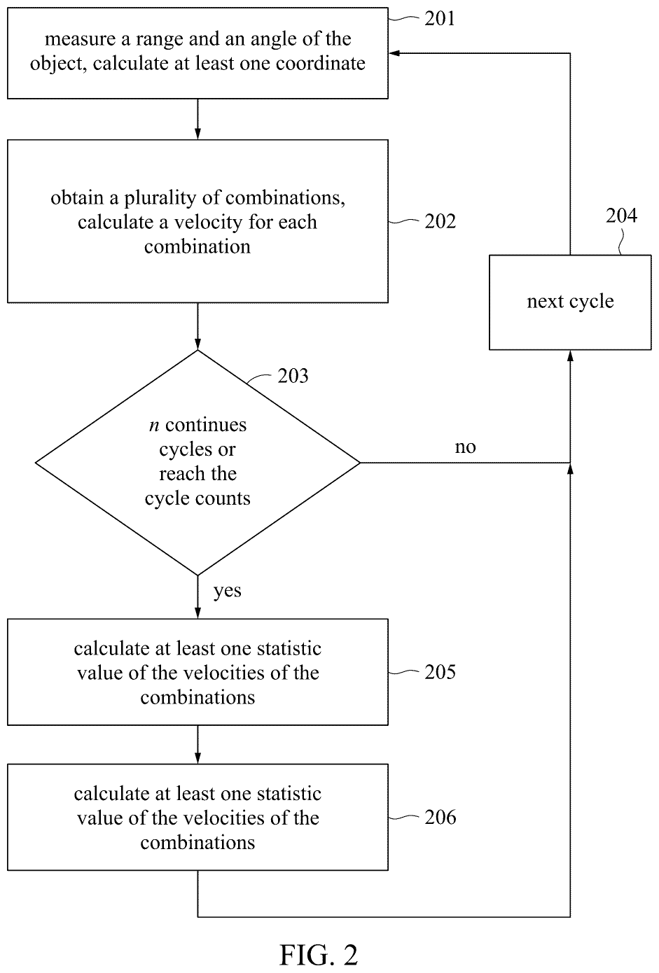

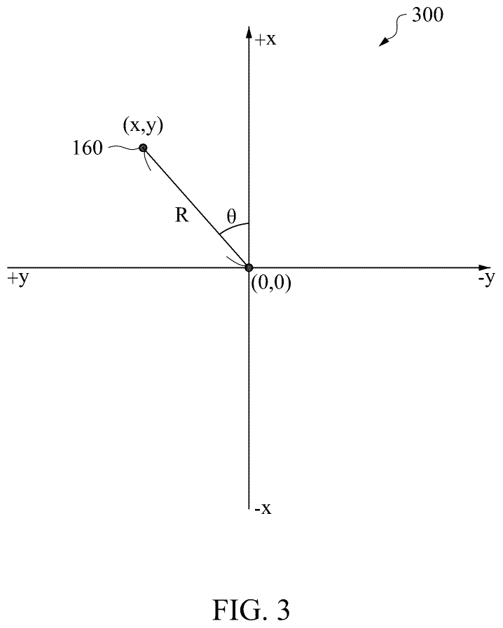

FIG. 2 is a flowchart illustrating a velocity correction method according to one embodiment. Referring to FIG. 2, multiple cycles are set. Each cycle, for example, is set to be 50 microseconds, although the disclosure is not limited thereto. Steps 201-203 are executed in each cycle. In step 201, a range (hereinafter represented as R) and an angle (hereinafter represented as 0) of the object 160 relative to the radar system 100 are measured based on the aforementioned RF signals, and at least one coordinate is calculated based on the range and the angle. Referring to FIG. 3, a coordinate system 300 of the radar system 100 includes an X-axis and a Y-axis, where the coordinate (0,0) represents the position of the radar system 100. The object 160 is positioned at a distance of R and an angle of θ relative to the radar system. In this embodiment, the X-coordinate and Y-coordinate will be calculated as shown in the following Equation 1.

$$\begin{matrix}{x}_{i} = {R}_{i} \cdot cos ( {θ}_{i} ) \\ {y}_{i} = {R}_{i} \cdot sin ( {θ}_{i} )\end{matrix} \qquad [ Equation 1 ]$$

Where Rᵢ represents the range measured in the i-th cycle, θᵢ represents the angle measured in the i-th cycle. xᵢ represents the X-coordinate (also referred to as a first coordinate) calculated in the i-th cycle, and yᵢ represents the Y-coordinate (also referred to as a second coordinate) calculated in the i-th cycle. i is a positive integer.

Referring to FIG. 2, Step 202 is executed next, where multiple combinations among multiple cycles are obtained, each combination corresponding to two cycles. If 10 cycles have already passed, then C₂¹⁰=45 combinations will be obtained; if 15 cycles have passed, then C₂¹⁵=105 combinations will be obtained. In other words, the aim here is to obtain all combinations of any two of the cycles. Additionally, for each combination, the velocity on the X-axis (also referred to as a first velocity) and the velocity on the Y-axis (also referred to as a second velocity) will be calculated based on the corresponding coordinates and a cycle difference. Assuming a k-th combination corresponds to the i-th and j-th cycles, where i>j, and k, i and j are positive integers, the calculation for the X-axis and Y-axis velocities is shown in the following Equation 2.

$$\begin{matrix}{v}_{x , k} = \frac{( {x}_{i} - {x}_{j} )}{Δ T \cdot ( i - j )} \\ {v}_{y , k} = \frac{( {y}_{i} - {y}_{j} )}{Δ T \cdot ( i - j )}\end{matrix} \qquad [ Equation 2 ]$$

Where v_{x,k} is the X-axis velocity for the k-th combination, and v_{y,k} is the Y-axis velocity for the k-th combination. ΔT is the cycle time, for example, 50 microseconds, and (i-j) is the aforementioned cycle difference. For instance, if there are a total of 4 cycles, then there would be C₂⁴=6 combinations. The X-axis velocities for these 6 combinations are shown in the following Equation 3.

$$\begin{matrix}{v}_{x , 1} = \frac{( {x}_{2} - {x}_{1} )}{Δ T} \\ {v}_{x , 2} = \frac{( {x}_{3} - {x}_{1} )}{Δ T \cdot 2} \\ {v}_{x , 3} = \frac{( {x}_{3} - {x}_{2} )}{Δ T} \\ {v}_{x , 4} = \frac{( {x}_{4} - {x}_{1} )}{Δ T \cdot 3} \\ {v}_{x , 5} = \frac{( {x}_{4} - {x}_{2} )}{Δ T \cdot 2} \\ {v}_{x , 6} = \frac{( {x}_{4} - {x}_{3} )}{Δ T}\end{matrix} \qquad [ Equation 3 ]$$

Next, in step 203, it is determined whether there are n continuous cycles with small changes or whether the number of processed cycles is greater than a cycle count, where n is a positive integer. If not, then proceed to step 204 to process the next cycle; otherwise, proceed to steps 205-206.

Specifically, the aforementioned cycle count is a constant. In some embodiments, this cycle count is set during the first cycle. If the range R₁ is greater than a range threshold (e.g., 70 meters), the cycle count is set to be a first value; otherwise, it is set to be a second value, where the first value is greater than the second value. For example, the first value is 15, and the second value is 10, although the disclosure is not limited to these values. When the range R₁ is larger, the measured velocity has a greater error. Therefore, setting a larger cycle count can reduce this error, but this will result in a delayed-produced correction. Consequently, a smaller cycle count is set when R₁ is smaller to correct the velocity more quickly. If the number of cycles currently processed has not yet exceeded the cycle count, then proceed to the next cycle (i.e. step 204); if the number of cycles has exceeded the cycle count, then also proceed to the step 205.

On the other hand, the aforementioned step to determine if there are n continuous cycles involves checking whether the difference between corresponding X-axis velocities across these consecutive n cycles is less than a velocity threshold when the number of cycles currently processed has not yet exceeded the cycle count, and likewise for the Y-axis velocities. Here, n is an integer greater than 1. For example, when n=4, four X-axis velocities are obtained from the aforementioned combinations, namely v_{x,k}, v_{x,k-1}, v_{x,k-2}, and v_{x,k-3}, as well as four Y-axis velocities, namely v_{y,k}, v_{y,k-1}, v_{y,k-2}, and v_{y,k-3}. Subsequently, it is determined whether the following Equation 4 holds.

$$\begin{matrix}\vert {v}_{x , k} - {v}_{x , k - 1} \vert < {V}_{T} and \vert {v}_{x , k - 1} - {v}_{x , k - 2} \vert < {V}_{T} and \\ \vert {v}_{x , k - 2} - {v}_{x , k - 3} \vert < {V}_{T} and \vert {v}_{y , k} - {v}_{y , k - 1} \vert < {V}_{T} and \\ \vert {v}_{y , k - 1} - {v}_{y , k - 2} \vert < {V}_{T} and \vert {v}_{y , k - 2} - {v}_{y , k - 3} \vert < {V}_{T}\end{matrix} \qquad [ Equation 4 ]$$

In this context, k is an appropriate positive integer where k≥4. VT represents the velocity threshold, for example, 1 m/s. In other embodiments, any n velocities can be taken from the aforementioned combinations for the assessment; the disclosure is not limited to Equation 4. If Equation 4 does not hold, this indicates a significant disparity in the velocities calculated across different cycles, needing further measurements of additional cycles and thus proceeding to the step 204. If Equation 4 holds, it indicates that the calculated velocities have stabilized, thus proceeding to the steps 205-206 instead of processing the next cycle.

In step 205, at least one statistical value corresponding to the velocities (including both X-axis and Y-axis velocities) from the aforementioned combinations is calculated. In this implementation, these statistical values include a mean and a standard deviation.

In step 206, the corrected velocity is calculated based on the statistical values. In this implementation, a grouping range is first established using the mean and standard deviation. For instance, the mean of the X-axis velocity is denoted as meanᵥₓ, and the standard deviation as stdᵥₓ. The aforementioned grouping range lies between (meanᵥₓ−m×stdᵥₓ) and (meanᵥₓ+m×stdᵥₓ), where m is a positive integer. When m=1, the grouping range spans from the mean minus the standard deviation to the mean plus the standard deviation. Subsequently, the velocities v_{x,k} within the grouping range are separated into multiple bins, and a most repeating bin within these bins is used to determine the corrected velocity. A similar process is also applied to the Y-axis velocities, where the mean and standard deviation are denoted as mean_{vy} and std_{vy}, respectively, and the corresponding grouping range is between (mean_{vy}−m×std_{vy}) and (mean_{vy}+m×std_{vy}).

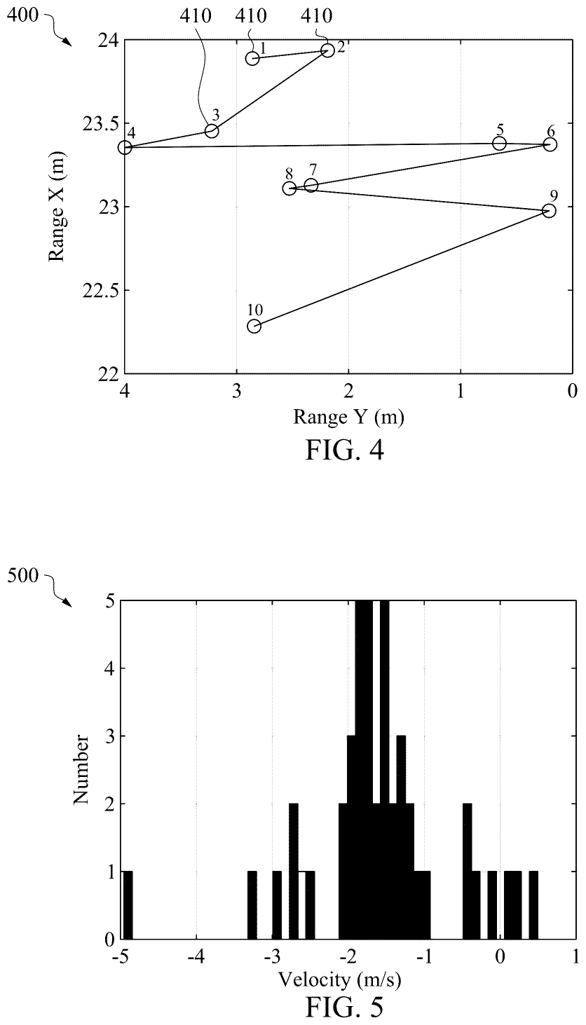

FIGS. 4 to 6 illustrate data diagrams for calculating the corrected velocity according to an embodiment. Referring to FIG. 4, the horizontal axis of a diagram 400 represents the Y-axis coordinates, while the vertical axis represents the X-axis coordinates. Multiple points 410 represent the detected position of the object, and the numbers adjacent to the points 410 indicate the cycle number. For example, the position of the object detected in the first cycle is approximately at (x=23.9, y=2.9), and in the second cycle, it is approximately at (x=23.91, y=2.15). As can be seen from FIG. 4, the positions of the detected object within the first 10 cycles are quite dispersed, indicating lack of precision.

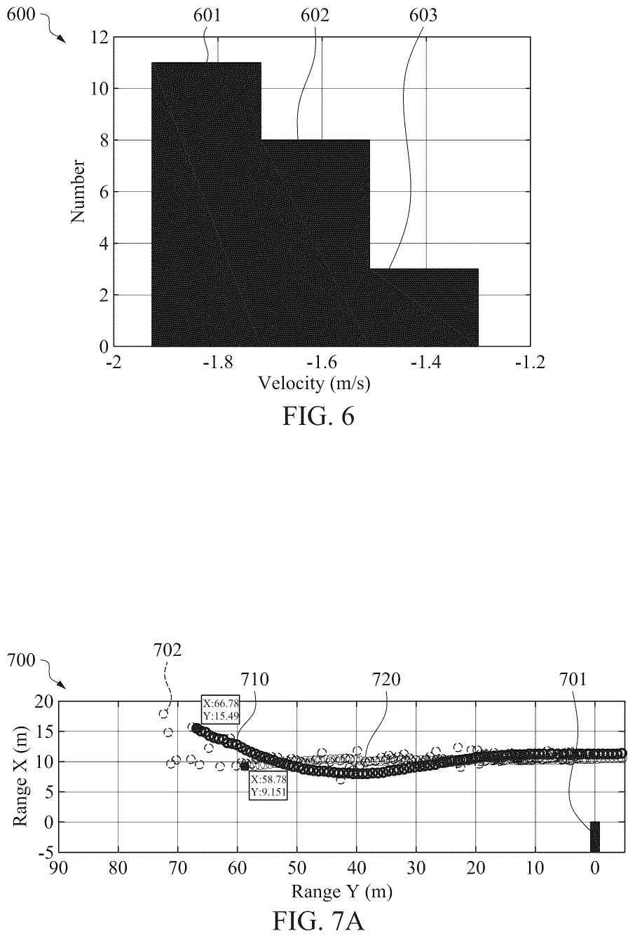

After the calculations in steps 201-204 as shown in FIG. 2, multiple combinations and corresponding velocities can be obtained. Taking X-axis velocities as examples, these velocities are plotted in a diagram 500 of FIG. 5, where the horizontal axis represents the X-axis velocity and the vertical axis represents the number of combinations. In the example shown in FIG. 5, the majority of velocities are distributed between −3 and 0. After the calculations in step 205 of FIG. 2, the mean of these velocities is-1.5952 m/s, and the standard deviation is 0.9539 m/s. In this embodiment, the grouping range is set between (−1.5952−0.9539) and (−1.5952+0.9539). Subsequently, the velocities within this grouping range are taken and separated into multiple bins. Referring to a diagram 600 of FIG. 6, the horizontal axis represents the X-axis velocity, and the vertical axis represents the number of combinations (which also indicates the repetition count for each bin). The width of these bins is predefined, for example, as 0.2. For simplicity, only three bins 601-603 are shown. The bin 601 has a repetition count of 11, the bin 602 has a repetition count of 8, and the bin 603 has a repetition count of 3. Therefore, the bin 601 (also referred to as a most repeating bin) has the maximum repetition count, and its center (which is −1.82) is taken as the corrected velocity.

FIGS. 4 to 6 are examples based on X velocity. The same process can be applied to Y velocity, which will not be redundantly elaborated here. After calculating the corrected velocity, the processing circuit 150 can execute a clustering algorithm, an association algorithm, or a tracking algorithm based on this corrected velocity. The clustering algorithm aims to categorize velocities to distinguish different objects. The association algorithm aims to relate the velocity calculated in the current cycle to the velocity from the previous cycle. The tracking algorithm aims to track the trajectory of an object. However, in other embodiments, the processing circuit 150 can also execute other suitable algorithms based on these corrected velocities; the present disclosure is not limited in this respect. Referring back to FIG. 2, after calculating the corrected velocity, the process returns to the step 204, enter the next cycle, and go back to the step 201.

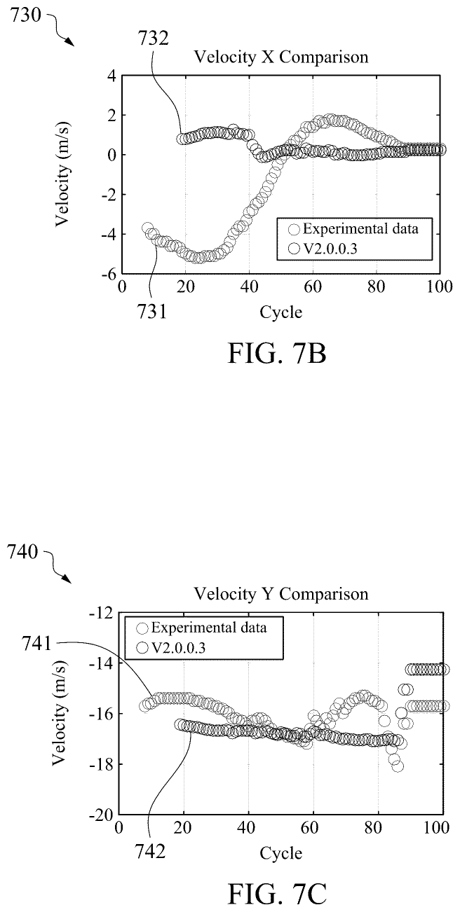

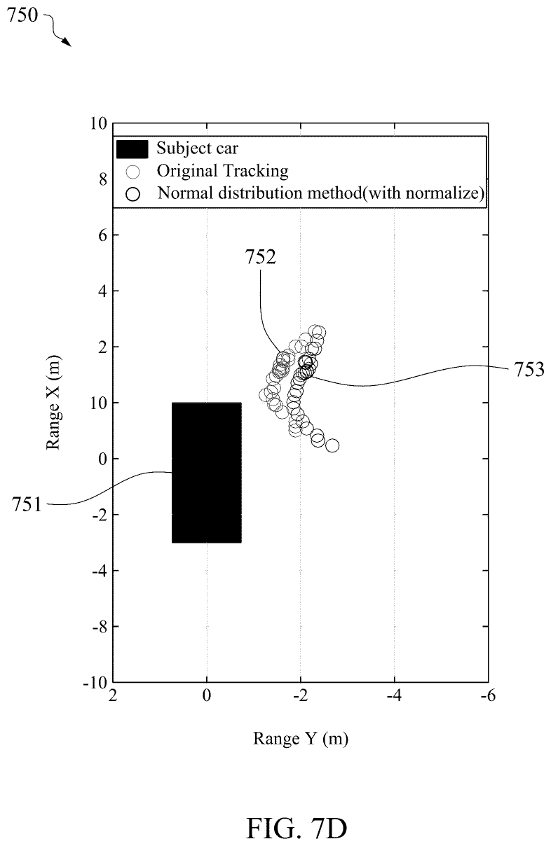

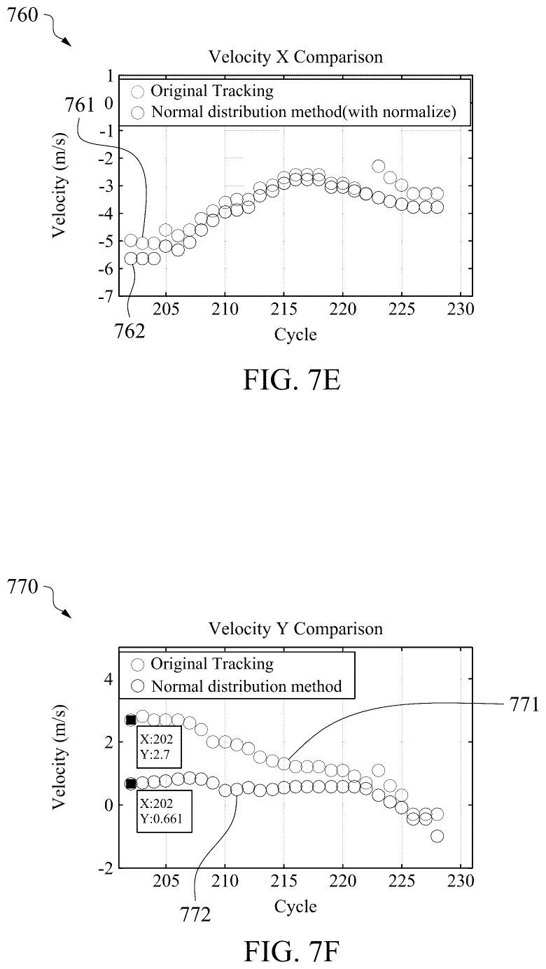

FIG. 7A to FIG. 7F illustrate diagrams of experimental results according to embodiments. Referring to FIG. 7A, the horizontal axis of a diagram 700 represents the Y-axis coordinate, and the vertical axis represents the X-axis coordinate. A marker 701 indicates the position of the radar system 100. In this experiment, the experimental object moves linearly from the position (x=10, y=70) to the position (x=10, y=−10). Positions measured by the radar system are indicated by circles 702. It can be observed that the positions of the circles 702 are very scattered in the initial cycles, showing lack of precision. If the tracking algorithm is executed without performing velocity correction, a trajectory 710 is produced which composed of circles labeled as 710. After executing the aforementioned velocity correction method and then running the tracking algorithm, a trajectory 720 is produced which composed of circles labeled as 720. It can be seen from FIG. 7A that the trajectory 720 is delayed by a few cycles because it takes a few cycles to calculate multiple combinations. Moreover, compared to the trajectory 710, the trajectory 720 is more stable and better aligned with the linear movement from (x=10, y=70) to (x=10, y=−10). Referring to FIGS. 7A and 7B, the horizontal axis of a diagram 730 indicates cycles, and the vertical axis of the diagram 730 indicates the X-axis velocity. Circles 731 are the estimated X-velocities of the trajectory 710. Circles 732 are the corrected X-velocities of the trajectory 720. Referring to FIGS. 7A and 7C, the horizontal axis of a diagram 740 indicates cycles, and the vertical axis of the diagram 740 indicates the Y-axis velocity. Circles 741 are the estimated Y-velocities of the trajectory 710. Circles 742 are the corrected Y-velocities of the trajectory 720. It is shown in FIGS. 7B and 7C that the circles 732 and 742 with correction are more stable and better aligned with the linear movement from (x=10, y=70) to (x=10, y=−10).

Referring to FIG. 7D, the horizontal axis of a diagram 750 represents the Y-axis coordinate, and the vertical axis represents the X-axis coordinate. A marker 751 indicates the position of the radar system 100. In this experiment, the experimental object moves from bottom overtaking the marker 751 at very slow speed at y=−2 m. The Y-axis velocity of the experimental object is approximately equal to 0, and the X-axis velocity of the experimental object is a certain value for overtaking the marker 751. If the tracking algorithm is executed without performing velocity correction, a trajectory 752 is produced which composed of circles labeled as 752. After executing the aforementioned velocity correction method and then running the tracking algorithm, a trajectory 753 is produced which composed of circles labeled as 753. In the absence of correction, the experimental object on the trajectory 752 appears to be moving inward and may seem to be on a collision course with the marker 751. However, the trajectory 753 provides correct information to detect if the collision occurs. Referring to FIGS. 7D and 7E, the horizontal axis of a diagram 760 indicates cycles, and the vertical axis of the diagram 760 indicates the X-axis velocity. Circles 761 are the estimated X-velocities of the trajectory 752. Circles 762 are the corrected X-velocities of the trajectory 753. Referring to FIGS. 7D and 7F, the horizontal axis of a diagram 770 indicates cycles, and the vertical axis of the diagram 770 indicates the Y-axis velocity. Circles 771 are the estimated Y-velocities of the trajectory 752. Circles 772 are the corrected Y-velocities of the trajectory 753. It is shown in FIGS. 7E and 7F that the circles 762 and 772 with correction are more stable and better aligned with the linear movement from the bottom to overtake the marker 751.

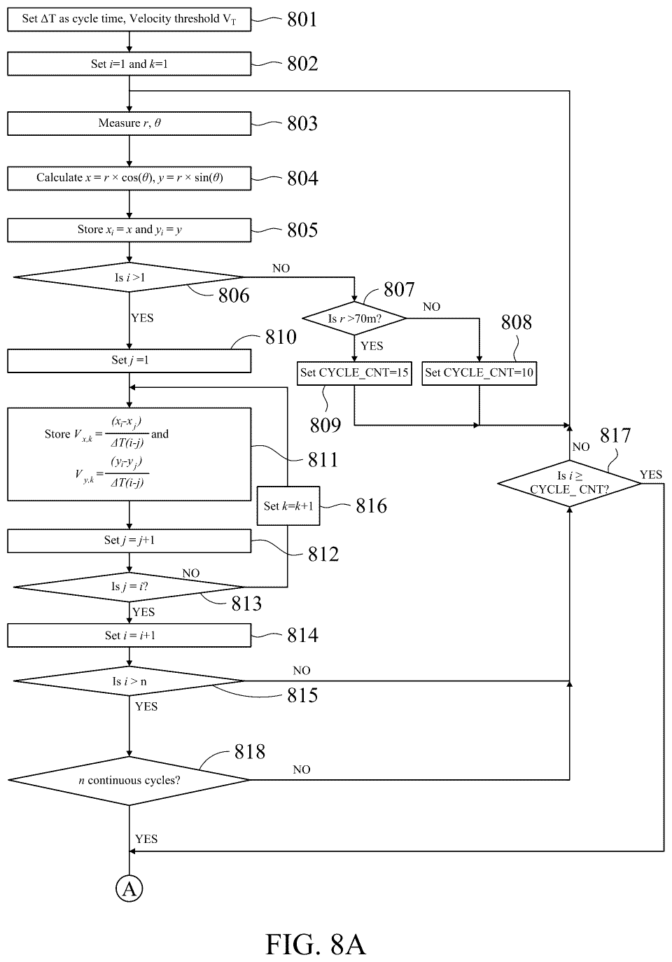

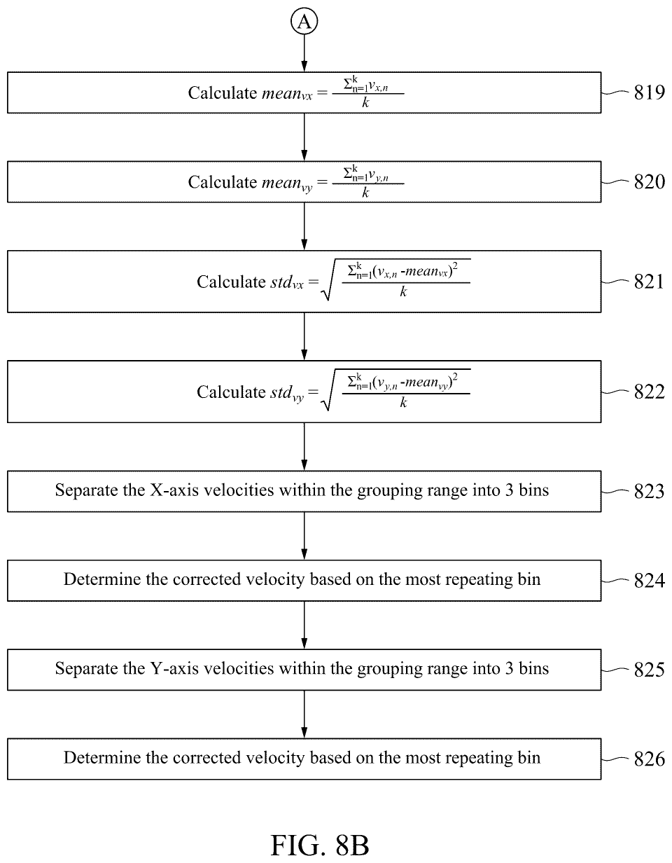

FIGS. 8A and 8B illustrate flowcharts of a velocity correction method according to another embodiment. Referring to FIG. 8A, in step 801, the cycle time ΔT and velocity threshold V_{T} are initially set. In step 802, the positive integers i and j are initialized, both being set to 1. In step 803, the range r and angle θ are measured. In step 804, the X and Y coordinates are calculated. In step 805, the X and Y coordinates are stored in a memory (not shown). In step 806, it is determined whether the positive integer i is greater than 1, where i represents the cycle number. If i equals to 1, in step 807 it determines whether the range r is greater than 70 meters. If the range r is greater than 70 meters, the cycle count (i.e., CYCLE_CNT) is set to 15 in step 809; otherwise, the cycle count is set to 10 in step 808. Subsequently, the process returns to step 803 for the next cycle.

If the positive integer i is greater than 1, in step 810, the positive integer j is set to 1. In step 811, the X-axis and Y-axis velocities are calculated according to the aforementioned Equation 2. In step 812, the positive integer j is incremented by 1. In step 813, it is determined whether j equals to i; if not, it means that not all combinations have been processed, the step 816 is performed to increase k by 1 and then the process returns to step 811. If j equals to i, the positive integer i is increased by 1 in step 814. In step 815, it is determined whether i is greater than the integer n. If i is not greater than n in step 817, it is determined whether i is greater than or equal to the cycle count. If i is not greater than or equal to the cycle count, the process proceeds to the next cycle and returns to step 803. If i is greater than or equal to the cycle count, the flow of FIG. 8A terminates. On the other hand, if the determination in step 815 is affirmative, in step 818, it is determined whether there are n continuous cycles with small changes as described above; if so, the flow in FIG. 8A terminates; otherwise, the process returns to step 816.

Referring to FIG. 8B, in step 819, the mean of the X-axis velocities is calculated. In step 820, the mean of the Y-axis velocities is calculated. In step 821, the standard deviation of the X-axis velocities is calculated. In step 822, the standard deviation of the Y-axis velocities is calculated. In step 823, the X-axis velocities within the grouping range are separated into 3 bins. In step 824, the corrected velocity (for X-axis) is determined based on the most repeating bin. In step 825, the Y-axis velocities within the grouping range are divided into 3 bins. In step 826, the corrected velocity (for Y-axis) is determined based on the most repeating bin.

In the aforementioned radar system and velocity correction method, by setting multiple combinations to generate the corrected velocity, measurement errors can be eliminated, resulting in more accurate and stable velocities.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A radar system, comprising:
a plurality of radio frequency (RF) circuits, configured to obtain a plurality of RF signals with respect to an object; and
a processing circuit electrically connected to the radio frequency circuits, and configured to measure a range and an angle of the object related to the radar system according to the RF signals, and calculate at least one coordinate according to the range and the angle in each of a plurality of cycles,
wherein the processing circuit is configured to obtain a plurality of combinations among the cycles, wherein each of the combinations corresponds to two of the cycles,
wherein for each of the combinations, the processing circuit is configured to calculate at least one velocity according to the corresponding coordinates and a cycle difference,
wherein the processing circuit is configured to calculate at least one statistic value of the velocities of the combinations, and calculate a corrected velocity according to the at least one statistic value.

2. The radar system of claim 1, wherein the at least one coordinate comprises a first coordinate and a second coordinate, and the processing circuit is configured to calculate the first coordinate and the second coordinate based on following equations:
xᵢ=Rᵢ· cos(θD)
yᵢ=Rᵢ·sin(θᵢ)
wherein Rᵢ is the range measured in a i-th cycle of the cycles, θᵢ is the angle measured in the i-th cycle, xᵢ is the first coordinate calculated in the i-th cycle, yᵢ is the second coordinate calculated in the i-th cycle, and i is a positive integer.

3. The radar system of claim 2, wherein the at least one velocity comprises a first velocity and a second velocity, a k-th combination of the combinations corresponds to the i-th cycle and a j-th cycle, and the processing circuit is configured to calculate the first velocity and the second velocity based on following equations:
$$\begin{matrix}{v}_{x , k} = \frac{( {x}_{i} - {x}_{j} )}{Δ T \cdot ( i - j )} \\ {v}_{y , k} = \frac{( {y}_{i} - {y}_{j} )}{Δ T \cdot ( i - j )}\end{matrix}$$
wherein v_{x,k} is the first velocity of the k-th combination, v_{y,k} is the second velocity of the k-th combination, ΔT is cycle time, and k is a positive integer.

4. The radar system of claim 3, wherein the processing circuit is configured to determine if a number of the cycles is greater than a cycle count, and if not, process a next cycle, and if yes, stop processing the next cycle.

5. The radar system of claim 4, wherein the processing circuit is configured to determine, in one of the cycles, if the corresponding range is greater than a range threshold, and if yes, set the cycle count to be a first value, and if not, set the cycle count to be a second value, wherein the first value is greater than the second value.

6. The radar system of claim 3, wherein the processing circuit is configured to determine if a difference among the first velocities of n continuous cycles is less than a velocity threshold and a difference among the second velocities of the n continuous cycles is less than the velocity threshold, and if yes, stop processing a next cycle, and if not, process the next cycle, wherein n is a positive integer greater than 1.

7. The radar system of claim 1, wherein the at least one statistic value comprises a mean and a standard deviation of the velocities of the combinations,
wherein the processing circuit is configured to set a grouping range according to the mean and the standard deviation, separate the velocities within the grouping range into a plurality of bins, and determine the corrected velocity according to a most repeating bin of the bins.

8. The radar system of claim 7, wherein the processing circuit is configured to set the grouping range to be from the mean minus the standard deviation to the mean plus the standard deviation.

9. The radar system of claim 7, wherein the processing circuit is configured to set a center of the most repeating bin to be the corrected velocity.

10. The radar system of claim 1, wherein the processing circuit is configured to perform a clustering algorithm, an association algorithm, or a tracking algorithm according to the corrected velocity.

11. A velocity correction method for a radar system and performed by a processing circuit, the velocity correction method comprising:
obtaining, by a plurality of radio frequency (RF) circuits, a plurality of RF signals with respect to an object;
measuring a range and an angle of the object related to the radar system according to the RF signals, and calculating at least one coordinate according to the range and the angle in each of a plurality of cycles;
obtaining a plurality of combinations among the cycles, wherein each of the combinations corresponds to two of the cycles;
for each of the combinations, calculating at least one velocity according to the corresponding coordinates and a cycle difference; and
calculating at least one statistic value of the velocities of the combinations, and calculating a corrected velocity according to the at least one statistic value.

12. The velocity correction method of claim 11, wherein the at least one coordinate comprises a first coordinate and a second coordinate, and the step of calculating the at least one coordinate comprises:
calculate the first coordinate and the second coordinate based on following equations:
xᵢ=Rᵢ· cos(θᵢ)
yᵢ=Rᵢ·sin(θᵢ)
wherein Rᵢ is the range measured in a i-th cycle of the cycles, θᵢ is the angle measured in the i-th cycle, xᵢ is the first coordinate calculated in the i-th cycle, yᵢ is the second coordinate calculated in the i-th cycle, and i is a positive integer.

13. The velocity correction method of claim 12, wherein the at least one velocity comprises a first velocity and a second velocity, a k-th combination of the combinations corresponds to the i-th cycle and a j-th cycle, and the step of calculating the at least one velocity comprises:
calculating the first velocity and the second velocity based on following equations:
$$\begin{matrix}{v}_{x , k} = \frac{( {x}_{i} - {x}_{j} )}{Δ T \cdot ( i - j )} \\ {v}_{y , k} = \frac{( {y}_{i} - {y}_{j} )}{Δ T \cdot ( i - j )}\end{matrix}$$
wherein v_{x,k} is the first velocity of the k-th combination, v_{y,k} is the second velocity of the k-th combination, ΔT is cycle time, and k is a positive integer.

14. The velocity correction method of claim 13, wherein before the step of calculating the at least one statistic value, the velocity correction method further comprises:
determining if a number of the cycles is greater than a cycle count, and if not, process a next cycle, and if yes, stop processing the next cycle.

15. The velocity correction method of claim 14, further comprising:
determining, in one of the cycles, if the corresponding range is greater than a range threshold, and if yes, set the cycle count to be a first value, and if not, set the cycle count to be a second value, wherein the first value is greater than the second value.

16. The velocity correction method of claim 13, wherein before the step of calculating the at least one statistic value, the velocity correction method further comprises:
determining if a difference among the first velocities of n continuous cycles is less than a velocity threshold and a difference among the second velocities of the n continuous cycles is less than the velocity threshold, and if yes, stop processing a next cycle, and if not, process the next cycle, wherein n is a positive integer greater than 1.

17. The velocity correction method of claim 11, wherein the at least one statistic value comprises a mean and a standard deviation of the velocities of the combinations, and velocity correction method further comprises:
setting a grouping range according to the mean and the standard deviation, separate the velocities within the grouping range into a plurality of bins, and determine the corrected velocity according to a most repeating bin of the bins.

18. The velocity correction method of claim 17, further comprising:
setting the grouping range to be from the mean minus the standard deviation to the mean plus the standard deviation.

19. The velocity correction method of claim 17, further comprising:
setting a center of the most repeating bin to be the corrected velocity.

20. The velocity correction method of claim 11, further comprising:
performing a clustering algorithm, an association algorithm, or a tracking algorithm according to the corrected velocity.
